(19) United States
(12) Patent Application Publication
(10) Pub. No.: US 2020/0015312 A1
(43) Pub. Date: Jan. 9, 2020

(54) METHOD AND DEVICE FOR DETERMINING DISCONTINUOUS RECEPTION CONFIGURATION

(71) Applicant: ZTE CORPORATION, Shenzhen (JP)

(72) Inventors: Qingchun HE, Shenzhen (CN); He HUANG, Shenzhen (CN); Yin GAO, Shenzhen (CN); Nan LI, Shenzhen (CN)

(21) Appl. No.: 16/338,408

(22) PCT Filed: Sep. 29, 2017
(86) PCT No.: PCT/CN2017/104618

§ 371 Date: Mar. 29, 2019

(30) Foreign Application Priority Data
Sep. 30, 2016 (CN) 201610879082.0

(51) Int. Cl. H04W 76/28; H04W 76/11; H04W 72/04; H04W 76/27; H04W 80/02

(52) U.S. Cl. CPC H04W 76/28; H04W 76/11; H04W 80/02; H04W 72/0446; H04W 76/27; H04W 72/042

(57) ABSTRACT

A method for determining discontinuous reception (DRX) configuration information includes: determining, by a terminal or a base station, according to a service type of a service being used, and according to mapping relationships between different service types and DRX configurations, a DRX configuration corresponding to the service. The technical solution provided in the disclosure is utilized to select, according to different service types, a DRX parameter and a timer to configure a terminal, implementing a flexible DRX configuration for the terminal and with respect to various service types, ensuring power-saving of the terminal, and adapting to transmission latency requirements of different service characteristics, thereby meeting requirements of future technologies of mobile communication.

### CROSS REFERENCE

This application is the 371 application of PCT Application No. PCT/CN2017/104618 filed Sep. 29, 2017, which is based upon and claims priority to Chinese Patent Application No. 201610879082.0, filed on Sep. 30, 2016 the entire contents thereof are incorporated herein by reference.

### TECHNICAL FIELD

The present disclosure relates to the field of mobile communication technologies, and more particularly, to a method and a device for determining discontinuous reception configuration information.

### BACKGROUND

In the long term evolution (LTE)/the fourth-generation (4G) network, packet-based data streams are usually bursty, that is, there is data transmission for a period of time, but there is no data transmission for a coming long period of time. When there is no data transmission, the power consumption can be reduced by stopping receiving a Physical Downlink Control Channel (PDCCH) (the PDCCH blind check will be stopped at this time), thereby improving battery time, the above process is implemented by the network to configure a set of Discontinuous Reception (DRX) timers for the terminal. If each subframe is configured with an On Duration of DRX, a time interval between the two On Durations is short and power saving is not achieved. If the time interval between the two On Durations is long, the terminal power consumption can be reduced, but it will cause a large data transmission delay. Regardless of the number of services, since the network only configures the terminal with a set of DRX parameters, a trade-off between power consumption and delay is required, which makes it difficult to adapt to the diverse needs of the service.

The fifth generation (5G) mobile communication is compared with the LTE/4G network in following aspects. On the one hand, the data throughput is large, the delay is low, the reliability requirements are further improved, and the service types tend to be diversified, and the transmission characteristics are also different, for example, enhanced Mobile Broadband (eMBB) services are required to meet large bandwidth and high throughput, but have low latency requirements; massive Machine Type Communications (mMTC) services require networks to support massive user connections. The number of user connections has increased by a hundredfold; ultra-reliable and low latency communication (URLLC) have high requirement for latency and reliability. In other words, the DRX parameter configuration for the real-time and non-real-time services will be different to adapt to the characteristics of different service types and achieve the balance between delay and power consumption. For example, delay-insensitive services allow the terminal to sleep for as long as possible to reduce power consumption, while delay-sensitive services require terminals to be constantly woken up to meet latency requirements.

On the other hand, in the future, the terminal function becomes more powerful, and multiple types of services can be simultaneously performed. For example, when the terminal performs delay-insensitive and delay-sensitive services at the same time, if the implementation mode of only one set of DRX parameters configured for the terminal in the LTE network is followed, that is, only delay-insensitive DRX or delay-sensitive DRX is configured, which will not be well adapted to power saving of the terminal and transmission delay requirements of different service characteristics. In addition, the current DRX is based on the PDCCH or the Physical Downlink Shared Channel (PDSCH). If different physical layer parameters (numerology) in the 5G mobile communication correspond to different PDCCH types, different DRX parameters binding to the PDCCH type are also required as well.

Based on the above analysis, the non-continuous reception mode provided by relevant technologies cannot be flexibly configured terminals of various business types with DRX, so it cannot meet the requirements of future mobile communication technologies.

This section provides background information related to the present disclosure which is not necessarily prior art.

### SUMMARY

In order to solve the above technical problem, the present disclosure provides a method and a device for determining discontinuous reception configuration information, which can perform flexible DRX configuration on a terminal for multiple service types, thereby adapting to future mobile communication technology requirements.

For the purpose of this disclosure, the disclosure provides a method for determining the discontinuous reception configuration information, including:

receiving, by a terminal, a mapping relationship configured by a base station, between different service type information and discontinuous reception DRX configuration information; and

determining, by the terminal according to service type information of currently-used service and the mapping relationship, the DRX configuration information corresponding to the currently-used service.

The disclosure provides a method for determining discontinuous reception configuration information, including:

configuring, by a base station, a mapping relationship between different service type information and discontinuous reception DRX configuration information;

determining, by the base station according to service type information of currently-used service and the mapping relationship, the DRX configuration information corresponding to the currently-used service; and

sending, by the base station, the determined DRX configuration information to a terminal.

The disclosure provides a device for determining discontinuous reception configuration information, including a receiving module and a processing module.

The receiving module is configured to receive a mapping relationship configured by a base station, between different service type information and discontinuous reception DRX configuration information;

The processing module is configured to determine, according to service type information of currently-used service and the mapping relationship, the DRX configuration information corresponding to the service.

The disclosure provides a device for determining discontinuous reception configuration information, including a configuration module, a determination module, and a sending module; wherein,

The configuration module is configured to configure a mapping relationship between different service type information and discontinuous reception DRX configuration information;

The determination module is configured to determine, according to service type information of currently-used service and the mapping relationship, the DRX configuration information corresponding to the service;

The sending module is configured to send the determined DRX configuration information to a terminal.

The disclosure provides a user equipment UE, including: a communication interface, a memory, a processor and a bus; wherein, the bus is configured to connect the communication interface, the processor, and the memory; the communication interface is configured to perform data transmission with an external network element; the memory is configured to store instructions and data; and the processor executing the instructions is configured to: receive a mapping relationship configured by a base station, between different service type information and discontinuous reception DRX configuration information; and determine, according to service type information of currently-used service and the mapping relationship, the DRX configuration information corresponding to the currently-used service.

The disclosure provides a base station, including: a communication interface, a memory, a processor and a bus; wherein, the bus is configured to connect the communication interface, the processor, and the memory; the communication interface is configured to perform data transmission with an external network element; the memory is configured to store instructions and data; and the processor executing the instructions is configured to: configure a mapping relationship between different service type information and discontinuous reception DRX configuration information; determine, according to service type information of currently-used service and the mapping relationship, the DRX configuration information corresponding to the currently-used service; and send the determined DRX configuration information to a terminal.

The disclosure also provides a storage medium, configured to store program codes for performing any of the above methods.

Compared with the related art, the technical solution of the present application includes: determining, by the terminal or the base station, the DRX configuration information corresponding to the service according to the service type information of the currently-used service and the mapping relationship between the different service types and the DRX configuration information. According to the technical solution provided by the present disclosure, a DRX parameter and a timer are selected based on different service types, thus implementing flexible DRX configuration for a plurality of service types, so as to ensure good power saving of the terminal and, at the same time, adapt well to the transmission delay requirements of different service features, and to the requirements of future mobile communication technologies.

Other characteristics and advantages of the present disclosure will be described in the following specification, and will be apparent partly from the specification, or will be understood by implementing the embodiments of the present disclosure. The objective and other advantages of the present disclosure may be implemented and obtained by the specially indicated structure in the specification, claims and the accompany figures.

This section provides a summary of various implementations or examples of the technology described in the disclosure, and is not a comprehensive disclosure of the full scope or all features of the disclosed technology.

### BRIEF DESCRIPTION OF THE DRAWINGS

The drawings described herein are provided to provide a further understanding of the present disclosure, and are intended to be a part of the present disclosure. The illustrative embodiments of the present disclosure and the description thereof are for explaining the present disclosure and do not constitute an undue limitation of the present disclosure. In the drawings:

FIG. 1 is a schematic diagram illustrating a DRX cycle in the related art;

FIG. 2(a) is a flowchart illustrating a method for determining discontinuous reception configuration information;

FIG. 2(b) is a flowchart illustrating another method for determining discontinuous reception configuration information according to the present disclosure;

FIG. 3 is a block diagram illustrating a device for determining discontinuous reception configuration information according to the present disclosure;

FIG. 4 is a block diagram illustrating another device for determining discontinuous reception configuration information according to the present disclosure;

FIG. 5 is a flowchart illustrating a method for determining discontinuous reception configuration information according to a first embodiment of the present disclosure;

FIG. 6 is a flowchart illustrating a method for determining discontinuous reception configuration information according to a second embodiment of the present disclosure.

### DETAILED DESCRIPTION

In order to make the object, technical solution and advantage of the present disclosure more clear, the embodiments of the present disclosure will be described in detail below with reference to the accompanying drawings. It should be noted that, in the case of no conflict, the features in the embodiments and the embodiments in the present application may be arbitrarily combined with each other.

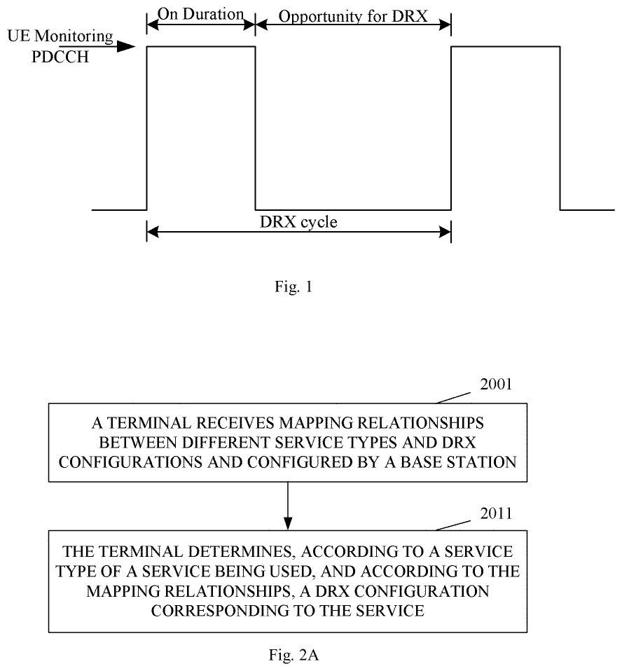

FIG. 1 is a schematic diagram illustrating a DRX cycle in the related art, as shown in FIG. 1, the basic mechanism of DRX is to configure a DRX cycle for the terminal in the RRC connection state. The DRX cycle consists of an On Duration and an Opportunity for DRX. During the on duration, the terminal monitors and receives the PDCCH; during the Opportunity for DRX, the terminal does not receive the PDCCH to reduce power consumption. The terminal in the Opportunity for DRX does not receive the PDCCH, but can receive data from other physical channels, such as PDSCH, acknowledgement information (ACK/NACK), and the like. For example, in the SPS scheduling, the terminal in the Opportunity for DRX may receive the PDSCH data sent on the downlink subframe of the periodic configuration.

The selection of DRX cycle needs to consider the balance between battery savings and latency. On the one hand, a long DRX-Cycle is beneficial to extend the battery life of the terminal. For example, during the web browsing process, when the user is reading the already downloaded webpage, it is a waste of resources that the terminal continuously receives the downlink data. On the other hand, when there is new data transmission, a shorter DRX-Cycle is beneficial for faster response, for instance when a user requests another web page or makes a VoIP call. In order to satisfy the above requirements, each terminal can be configured with two DRX cycles: a short DRX-Cycle and a long DRX-Cycle. If the terminal is configured with a short DRX-Cycle, the long DRX-Cycle should be configured as a multiple of short DRX-Cycle. However, in a LTE system, the terminal can only use one of the DRX configurations at any one time.

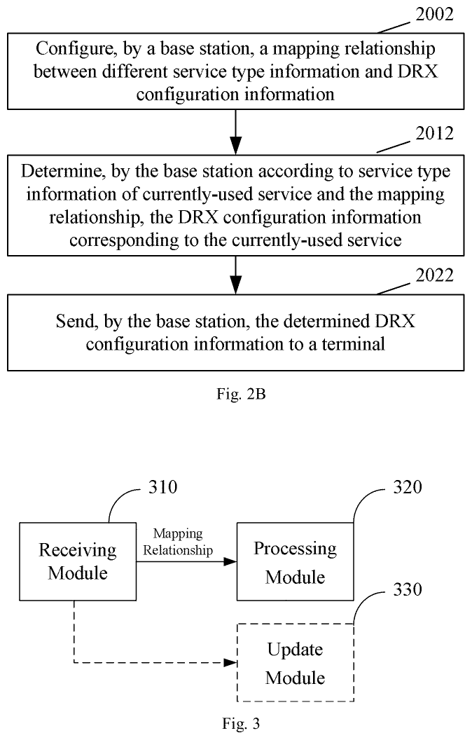

FIG. 2(a) is a flowchart illustrating a method for determining discontinuous reception configuration information. As shown in FIG. 2, steps 2001-2011 are included.

In step 2001, a terminal receives a mapping relationship configured by a base station, between different service type information and discontinuous reception DRX configuration information.

Prior to the step, the process include: generating, by the base station, the mapping relationship between different business types and DRX, and configuring the mapping relationship to the terminal.

Wherein, the mapping relationship include: mapping relationship between the service type information and the DRX configuration information; or mapping relationship between DRX index of the service type information and the DRX configuration information.

Here, the configuring the mapping relationship to the terminal can include the following information.

The base station indicates, through L3 control information and/or L2 control information, the generated DRX configuration information to the terminal semi-statically.

Or, the base station indicates, through physical downlink control indication information, the generated DRX configuration information to the terminal dynamically.

Here, the configuring the mapping relationship to the terminal can include the following information.

The base station sends multiple sets of the DRX configuration information to the terminal semi-statically and/or dynamically simultaneously.

In step 2011, the terminal determines, according to service type information of currently-used service and the mapping relationship, the DRX configuration information corresponding to the service.

The currently-used in this step is currently under way, that is, data is in the buffer, or the terminal receives the scheduling of the PDCCH or RNTI corresponding to the service.

When there are multiple services concurrent, it can be a merge process or an independent process. Wherein, the independent process includes: calculating an active time corresponding to each service independently and respectively according to the DRX configuration information corresponding to each service, and performing reception at each calculated active time. Wherein, the merge process includes: selecting minimum DRX configuration information, and receiving the service at its active time.

In a method of the present disclosure, the service type information includes: a radio bearer, and/or a logical channel, and/or a physical layer parameter; or a physical channel, and/or a radio network temporary identifier.

The DRX configuration information, determined in this step, corresponding to the service includes:

The DRX configuration information corresponding to the service type is determined by the terminal according to the radio bearer, and/or the logical channel, and/or the physical layer parameter, and the mapping relationship; or,

The DRX configuration information is selected by the terminal according to the physical channel, and/or the radio network temporary identifier and the mapping relationship.

Wherein, the physical layer parameter includes at least one of: subcarrier gap, symbol gap, subframe format, number of symbols included in a subframe, multiple access mode, and transmission time interval;

Wherein, the physical channel includes at least one of: physical downlink control channel PDCCH, enhanced physical downlink control channel ePDCCH, and physical downlink shared channel PDSCH.

In an embodiment, when the logical channel and/or the radio bearer and/or the physical layer parameter is changed, the process further includes:

The terminal updates the mapping relationship based on the DRX configuration information from the base station.

In an embodiment, the process further includes:

The terminal feeds back receipt confirmation message to the base station; wherein, the receipt confirmation message carries a reception state indication for indicating whether the DRX configuration information is successfully received.

FIG. 2(b) is a flowchart illustrating another method for determining discontinuous reception configuration information according to the present disclosure, as shown in FIG. 2(b), steps 2002-2022 are included.

In step 2002, a base station configures a mapping relationship between different service type information and DRX. The mapping relationship is shown as Table 1.

The mapping relationship between services and DRX in this step may include but is not limited to the following two types.

In one type, the mapping relationship between Radio Bearers (RBs) and/or Logical Channels (LCH) and/or Physical Layer Parameters and DRX configuration Information;

In an embodiment, in another type, the mapping relationship between a physical channel, and/or a radio network temporary identifier (RNTI) and the DRX configuration Information.

Wherein, the physical layer parameter may include at least one of: subcarrier gap, symbol gap, subframe format, number of symbols included in a subframe, multiple access mode, and transmission time interval.

Wherein, the type of service may be classified according to requirements such as transmission rate, and/or delay, and/or reliability, including but not limited to at least one of the following: eMBB, mMTC, URLLC, and the like.

Wherein, the physical channel includes, but is not limited to, at least one of: PDCCH, enhanced physical downlink control channel (ePDCCH), and physical downlink shared channel (PDSCH).

The mapping relationship may be shown as Table 1.

TABLE 1

| RBID/LCHID/RNTI/Physical Layer | |
|---|---|
| Parameter/Type of Physical Channel | DRX Configuration Information |
| Variable Identifier 1 | DRX configuration 1 |
| Variable Identifier 2 | DRX configuration 2 |
| . . . | . . . |
| Variable Identifier n | DRX configuration n |

The mapping relationship may be shown as Table 2.

TABLE 2

| DRX Index | DRX Configuration Information |
|---|---|
| 1 | DRX configuration 1 |
| 2 | DRX configuration 2 |
| . . . | . . . |
| n | DRX configuration n |

Different types of services have different requirements for transmission rate and transmission delay. In order to satisfy the service transmission characteristics, different physical layer parameters (numerology) are required for adaptation, and if different numerologies correspond to different PDCCH type in 5G mobile communication, then, different DRX parameters need to bind to the PDCCH type. Therefore, according to the method for implementing discontinuous reception of the present disclosure, the base station may generate one or more sets of DRX parameters for the terminal, and each set of DRX parameters is mapped with different radio bearers and/or logical channel and/or physical layer parameters are mapped.

In step 2012, the base station determines, according to service type information of currently-used service and the mapping relationship, the DRX configuration information corresponding to the service.

In step 2022, the base station sends the determined DRX configuration information to a terminal.

In the present step, the base station may indicate which DRX configuration information is used by the terminal through display of signaling (RRC/MAC/PHY); or the base station may use one or several DRX configurations through the current service selection of the terminal.

In one way, the base station indicates the determined DRX configuration information to the terminal semi-statically through L3 control information and/or L2 control information, that is, it is indicated which DRX configuration information the terminal uses; wherein, the L3 may be a radio resource controller (RRC), L2 may be a MAC Control Element (MAC CE).

In an embodiment, the base station indicates the determined DRX configuration information to the terminal dynamically through physical downlink control indication (DCI) information.

In an embodiment, the base station may choose to use some or some kinds of DRX configuration information through the ongoing service of the terminal at present.

In an embodiment, the base station sends the DRX configuration index to the terminal through the L3 control information and/or the L2 control information. Correspondingly, the terminal stores the mapping relationship between the DRX configuration index and the DRX configuration information corresponding to different service types, and the terminal can use the corresponding DRX parameter and timer based on the received configuration DRX index.

In an embodiment, the base station dynamically sends the DRX configuration index to the terminal through the DCI information. Correspondingly, the terminal stores the mapping relationship between the DRX configuration index and the DRX configuration information corresponding to different service types, and the terminal can use the corresponding DRX parameter and timer based on the received DRX configuration index.

In another way, the base station semi-statically and/or dynamically simultaneously transmits multiple sets of DRX configuration information to the terminal; accordingly, the terminal determines and uses the corresponding DRX configuration information according to different radio bearers and/or logical channels and/or physical layer parameters, or physical channels and/or RNTIs.

In an embodiment, when the DRX configuration information includes two or more sets, the base station only sends the DRX configuration information with the minimum DRX cycle to the terminal. In the processing manner of the present disclosure, when the terminal performs multiple services at the same time, and the service type changes relatively fast, the DRX configuration information with the minimum DRX cycle in the multiple sets of DRX configuration information is directly adopted, which reduces the implementation complexity.

In an embodiment, the method of the present disclosure further includes the following information.

The terminal feeds back receipt confirmation message to the base station.

The receipt confirmation message carries a reception state indication for indicating whether the DRX configuration information is successfully received. When the reception state indicates that the DRX configuration information is not successfully received, the base station needs to retransmit the DRX configuration information.

In an embodiment, the method of the present disclosure further includes:

When the service type and/or logical channel and/or radio bearer and/or physical layer parameters are changed, the DRX configuration information is triggered to be updated. In an embodiment, the method further includes: triggering to send the DRX configuration information to the terminal.

The technical solution provided by the present disclosure is to select a DRX parameter and a timer configuration terminal according to different service types, and implement a flexible DRX configuration for the terminal for multiple service types. While ensuring the power saving of the terminal, it also adapts well to the transmission delay requirements of different service characteristic, so as to adapt to the requirements of future mobile communication technologies.

FIG. 3 is a block diagram illustrating a device for determining discontinuous reception configuration information according to the present disclosure, as shown in FIG. 3, including a receiving module 310 and a processing module 320 at least; wherein,

The receiving module 310 is configured to receive a mapping relationship configured by a base station, between different service type information and discontinuous reception DRX configuration information.

The processing module 320 is configured to determine, according to service type information of currently-used service and the mapping relationship, the DRX configuration information corresponding to the service.

Currently-used data is in a buffer, or the terminal receives scheduling of PDCCH or RNTI corresponding to the service.

Wherein, the mapping relationship includes: the mapping relationship between the service type information and the DRX configuration information; or, the mapping relationship between DRX index of the service type information and the DRX configuration information.

Wherein, the service type information includes: a radio bearer, and/or a logical channel, and/or a physical layer parameter; or a physical channel, and/or a radio network temporary identifier.

The processing module 320 is exemplarily configured to: determine the DRX configuration information corresponding to the service type according to the radio bearer, and/or the logical channel, and/or the physical layer parameter, and the mapping relationship; or select the DRX configuration information according to the physical channel, and/or radio network temporary identifier, and the mapping relationship.

when the multiple currently-used services are included, the processing module 320 is exemplarily configured to: determine respective DRX configuration information respectively according to the DRX configuration information corresponding to the service type of each service; or select minimum DRX configuration information as the DRX configuration information corresponding to all services.

The device shown in FIG. 3 also includes an update module 330, configured to: update, when the logical channel and/or the radio bearer and/or the physical layer parameter is changed, the mapping relationship based on the DRX configuration information from the base station.

In one embodiment, the processing module 320 is further configured to: feed back, receipt confirmation message to the base station; wherein, the receipt confirmation message carries a reception state indication for indicating whether the DRX configuration information is successfully received.

The device for determining discontinuous reception configuration information shown in FIG. 3 of the present disclosure may be provided in the terminal.

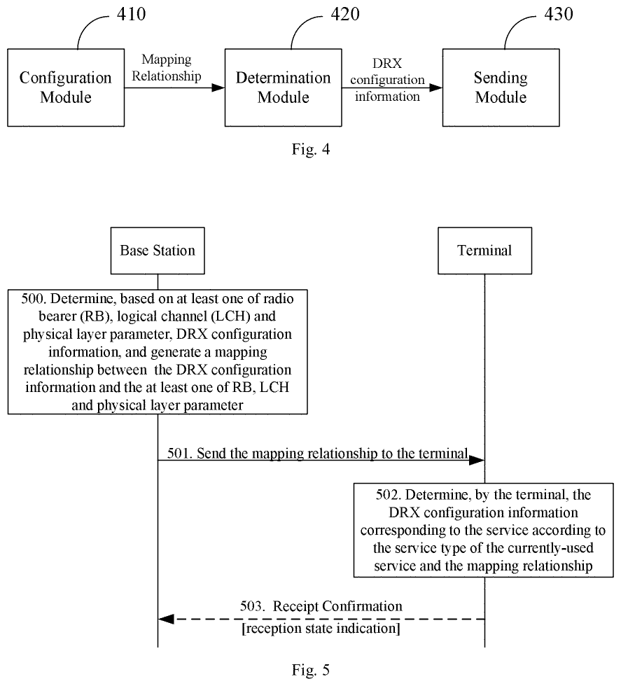

FIG. 4 is a block diagram illustrating another device for determining discontinuous reception configuration information according to the present disclosure, as shown in FIG. 4, including at least: a configuration module 410, a determination module 420, and a sending module 430; wherein,

The configuration module 410 is configured to configure a mapping relationship between different service type information and discontinuous reception DRX configuration information;

The determination module 420 is configured to determine, according to service type information of currently-used service and the mapping relationship, the DRX configuration information corresponding to the service;

The sending module 430 is configured to send the determined DRX configuration information to a terminal.

In an embodiment, the service type information may include but is not limited to: a radio bearer (RB), and/or a logical channel (LCH), and/or a physical layer parameter; or a physical channel, and/or a radio network temporary identifier (RNTI).

Wherein, the physical layer parameter includes at least one of: subcarrier gap, symbol gap, subframe format, number of symbols included in a subframe, multiple access mode, and transmission time interval.

Wherein, the type of service may be partitioned according to requirements such as transmission rate, and/or delay, and/or reliability, including but not limited to at least one of the following: eMBB, mMTC, URLLC, and the like.

Wherein, the physical channel includes at least one of: PDCCH, ePDCCH, and PDSCH.

Wherein, the DRX configuration information includes one or more sets, and different DRX configuration information is determined according to one or more different service types connected by the terminal.

In an embodiment, the sending module 430 is exemplarily configured in one of the following four ways.

The determined DRX configuration information is indicated to the terminal semi-statically through L3 control information and/or L2 control information;

Or, the determined DRX configuration information is indicated to the terminal dynamically through DCI information;

Or, DRX configuration index corresponding to the determined DRX configuration information is sent to the terminal through L3 control information and/or L2 control information; correspondingly, the terminal stores a mapping relationship between the DRX configuration index and the DRX configuration information corresponding to different service types, and the terminal can use the corresponding DRX parameter and timer according to the received DRX configuration index.

Or, the DRX configuration index corresponding to the determined DRX configuration information is sent to the terminal dynamically through DCI information; correspondingly, the terminal stores a mapping relationship between the DRX configuration index and the DRX configuration information corresponding to different service types, and the terminal can use the corresponding DRX parameter and timer according to the received DRX configuration index.

In an embodiment, the sending module 430 is exemplarily configured to send multiple sets of the DRX configuration information to the terminal semi-statically and/or dynamically simultaneously. Accordingly, the terminal determines and uses the corresponding DRX configuration information according to different radio bearers and/or logical channels and/or physical layer parameters, or physical channels and/or RNTIs.

In one embodiment, the determination module 420 is further configured to: trigger, when the service type and/or the logical channel and/or the radio bearer and/or the physical layer parameter is changed, an update of the DRX configuration information. In one embodiment, the determination module 420 is further configured to: indicate the sending module 430 to send the DRX configuration information.

In an embodiment, when the DRX configuration information includes two or more sets, the sending module 430 is exemplarily configured to: send the DRX configuration information with the minimum DRX cycle in the DRX configuration information to the terminal; accordingly, the terminal simultaneously performs multiple services, and the service types of multiple services change faster.

The device for determining discontinuous reception configuration information shown in FIG. 4 of the present disclosure is provided in a base station.

The technical solution of the present disclosure will be described in detail below in combined with the exemplary embodiment.

FIG. 5 is a flowchart illustrating a method for determining discontinuous reception configuration information according to a first embodiment of the present disclosure, in this embodiment, different services are mapped to different radio bearers and/or logical channels, and the base station selects the DRX parameter and timer for the terminal based on the radio bearer and/or logical channel used by the terminal, as shown in FIG. 5, including steps 500-503.

In step 500, the base station selects DRX configuration information such as the parameter and the timer based on the radio bearer and/or logical channel and/or physical layer parameter used, to generate a mapping relationship between the radio bearer and/or logical channel and/or physical layer parameter and DRX configuration information.

Wherein, the physical layer parameter includes at least one of: subcarrier gap, symbol gap, subframe format, number of symbols included in a subframe, multiple access mode, and transmission time interval.

Wherein, the DRX parameter and the timer are selected according to RB and/or LCH and/or physical layer parameter, and the mapping between the DRX parameter and the timer and RB and/or LCH and/or physical layer parameters is implemented.

Wherein, The RB and/or LCH and/or physical layer parameter is associated with the service type, that is, different types of services are mapped to the corresponding RBs and/or LCHs, and different physical layer parameters are adopted according to different types of service characteristics.

In an embodiment, when the service type and/or the logical channel and/or the radio bearer and/or the physical layer parameter is changed, the generation of mapping relationship between service and DRX parameter is triggered. In one embodiment, it also includes: triggering the sending of the mapping relationship and configuring the mapping relationship to the terminal.

Wherein, the DRX configuration information includes: a parameter and a timer of the DRX; or a DRX configuration index. The mapping relationship includes: mapping relationship between the service type information and the DRX configuration information; or mapping relationship between the DRX index of the service type information and the DRX configuration information.

In step 501, the base station configures the mapping relationship between the radio bearer and/or the logical channel and/or the physical layer parameter and the DRX parameter to the terminal.

In step 502, the terminal selects to use the DRX configuration information related to the service according to the service type of the currently ongoing service and the mapping relationship.

Wherein, currently-used data is in a buffer, or the terminal receives scheduling of PDCCH or RNTI corresponding to the service.

When the multiple currently-used service are included, the determining the DRX configuration information corresponding to the service include:

Respective DRX configuration information is determined respectively according to the DRX configuration information corresponding to the service type of each service;

Or, minimum DRX configuration information is selected as the DRX configuration information corresponding to all services.

When the logical channel and/or the radio bearer and/or the physical layer parameter is changed, the mapping relationship is updated based on the DRX configuration information from the base station.

In one embodiment, step 503 is also included.

In step 503, the terminal feeds back receipt confirmation message to the base station.

The receipt confirmation message carries a reception state indication for indicating whether the DRX configuration information is successfully received.

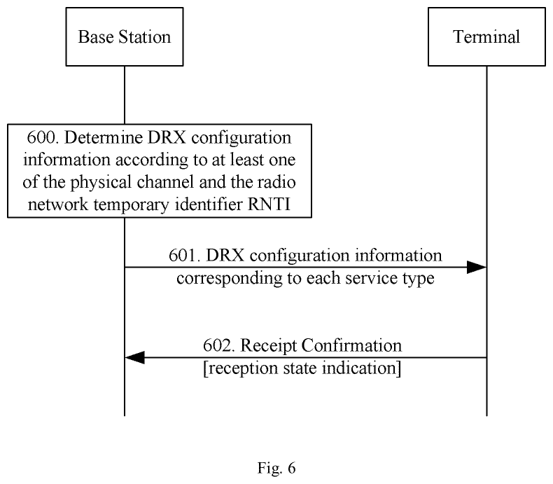

FIG. 6 is a flowchart illustrating a method for determining discontinuous reception configuration information according to a second embodiment of the present disclosure. In the present embodiment, the base station selects the DRX parameter according to the used physical channel and/or the radio network temporary identifier RNTI and sends the DRX parameter to the terminal, as shown in FIG. 6, including steps 600-602.

In step 600, the base station selects the DRX parameter and the timer according to the used physical channel and/or the RNTI.

The DRX parameter and the timer are selected according to the physical channel and/or the RNTI, and the DRX parameter and the mapping between the timer and the physical channel and/or the RNTI are implemented.

In an embodiment, the DRX configuration information is triggered to be updated when the physical channel changes and/or the RNTI changes. In one embodiment, it further includes: triggering to send the DRX configuration information.

In step 601, the base station sends the DRX configuration information with the minimum DRX cycle in the multiple DRX configuration information to the terminal.

In the present embodiment, it is assumed that the base station generates one or more sets of DRX configuration information, i.e., the DRX parameter and the timer, for the terminal according to the service type, and the base station sends the DRX configuration information with the minimum DRX cycle to the terminal.

Wherein, the base station may indicate which DRX configuration information is used by the terminal through display of signaling (L3/L2/L1). In an embodiment, the base station may use one or several DRX configurations through the currently ongoing service selection of the present terminal. In this embodiment, taking L3 as RRC and L2 as MAC CE as examples, the exemplary instructions mode in this step can be the following four modes.

In the first mode, the base station semi-statically indicates which DRX configuration used by the terminal through RRC and/or MAC CE.

In the second mode, the base station dynamically indicates which DRX configuration used by the terminal through DCI.

In the third mode, the base station sends the DRX configuration index to the terminal through the RRC and/or the MAC CE.

In the fourth mode, the base station semi-statically and/or dynamically simultaneously transmits multiple sets of DRX configuration information to the terminal. Accordingly, the terminal uses the corresponding DRX parameter and timer according to different radio bearers and/or logical channels and/or physical layer parameters, or physical channels and/or RNTIs.

In an embodiment, the base station can only send the DRX configuration information with the minimum DRX cycle in the multiple sets of DRX configuration information to the terminal.

In step 602, the terminal feeds back receipt confirmation message to network.

The receipt confirmation message carries a reception state indication for indicating whether the DRX configuration information is successfully received.

The above are only preferred embodiments of the present disclosure, and are not intended to limit the scope of the disclosure. Any modifications, equivalent substitutions, improvements, etc., made within the spirit and scope of the present disclosure shall be regarded as within the protection scope of the present disclosure.

1.-33. (canceled)

34. A method for determining discontinuous reception configuration information, comprising:
receiving, by a terminal, a mapping relationship configured by a base station, between different service type information and discontinuous reception DRX configuration information; and
determining, by the terminal according to service type information of currently-used service and the mapping relationship, the DRX configuration information corresponding to the currently-used service.

35. The method according to claim 34, wherein the currently-used service is indicated by data in a buffer, or indicated by scheduling of physical downlink control channel PDCCH or radio network temporary identifier RNTI corresponding to the service received by the terminal.

36. The method according to claim 34, wherein the mapping relationship comprises:
a mapping relationship between the service type information and the DRX configuration information; or
a mapping relationship between DRX index of the service type information and the DRX configuration information.

37. The method according to claim 34, wherein the service type information comprises at least one of: a radio bearer, a logical channel, and a physical layer parameter; or
the service type information comprises at least one of: a physical channel, and a radio network temporary identifier.

38. The method according to claim 37, wherein the physical layer parameter comprises at least one of: subcarrier gap, symbol gap, subframe format, number of symbols comprised in a subframe, multiple access mode, and transmission time interval; or
the physical channel comprises at least one of: physical downlink control channel PDCCH, enhanced physical downlink control channel ePDCCH, and physical downlink shared channel PDSCH.

39. The method according to claim 38, wherein the receiving, by a terminal, a mapping relationship configured by a base station comprises:
receiving, by the terminal, the mapping relationship indicated semi-statically by the base station through at least one of L3 control information and L2 control information; or
receiving, by the terminal, the mapping relationship indicated dynamically by the base station through physical downlink control indication information.

40. The method according to claim 38, wherein the receiving, by a terminal, a mapping relationship configured by a base station comprises:
receiving, by the terminal, multiple sets of the mapping relationship simultaneously sent by the base station in at least one of a semi-static way and a dynamic way.

41. The method according to claim 34, when there are a plurality of currently-used services, the determining the DRX configuration information corresponding to the currently-used service comprises:
determining respective DRX configuration information according to DRX configuration information corresponding to service type of each service; or
selecting minimum DRX configuration information as the DRX configuration information corresponding to all services.

42. The method according to claim 37, wherein when at least one of the logical channel, the radio bearer and the physical layer parameter is changed, the method further comprises:
updating, by the terminal, the mapping relationship based on the DRX configuration information from the base station.

43. The method according to claim 34, further comprising:
feeding back, by the terminal, a receipt confirmation message to the base station;
wherein the receipt confirmation message carries a reception state indication for indicating whether the DRX configuration information is successfully received.

44. A method for determining discontinuous reception configuration information, comprising:
configuring, by a base station, a mapping relationship between different service type information and discontinuous reception DRX configuration information;
determining, by the base station according to service type information of currently-used service and the mapping relationship, the DRX configuration information corresponding to the currently-used service; and
sending, by the base station, the determined DRX configuration information to a terminal.

45. The method according to claim 44, further comprising:
receiving, by the base station, a receipt confirmation message fed back from the terminal;
wherein, the receipt confirmation message carries a reception state indication for indicating whether the DRX configuration information is successfully received.

46. The method according to claim 44, wherein the service type information comprises at least one of: a radio bearer, a logical channel, and a physical layer parameter; or
the service type information comprises at least one of: a physical channel, and a radio network temporary identifier.

47. The method according to claim 46, wherein the physical layer parameter comprises at least one of: subcarrier gap, symbol gap, subframe format, number of symbols comprised in a subframe, multiple access mode, and transmission time interval; or
the physical channel comprises at least one of: physical downlink control channel PDCCH, enhanced physical downlink control channel ePDCCH, and physical downlink shared channel PDSCH.

48. The method according to claim 47, wherein the sending, by the base station, the determined DRX configuration information to a terminal comprises any one of following steps:
indicating, by the base station through at least one of L3 control information and L2 control information, the determined DRX configuration information to the terminal semi-statically;
indicating, by the base station through physical downlink control indication information, the determined DRX configuration information to the terminal dynamically;
sending, by the base station through at least one of L3 control information and L2 control information, a DRX configuration index corresponding to the determined DRX configuration information to the terminal; and
sending, by the base station through DCI information, the DRX configuration index corresponding to the determined DRX configuration information to the terminal dynamically.

49. The method according to claim 47, wherein the sending, by the base station, the determined DRX configuration information to a terminal comprises:
sending, by the base station, multiple sets of the DRX configuration information to the terminal in at least one of a semi-static way and a dynamic way simultaneously.

50. The method according to claim 46, wherein when at least one of the service type, the logical channel, the radio bearer and the physical layer parameter is changed, the method further comprises:
triggering an update of the DRX configuration information and sending the updated DRX configuration information to the terminal.

51. The method according to claim 44, wherein when there are two or more sets of the DRX configuration information, the sending, by the base station, the determined DRX configuration information to a terminal comprises:
sending, by the base station, the DRX configuration information with a minimum DRX cycle among the DRX configuration information to the terminal.

52. A user equipment UE, comprising a communication interface, a memory, a processor and a bus; wherein,
the bus is configured to connect the communication interface, the processor, and the memory;
the communication interface is configured to perform data transmission with an external network element;
the memory is configured to store instructions and data; and
the processor executing the instructions is configured to:
receive a mapping relationship configured by a base station, between different service type information and discontinuous reception DRX configuration information; and
determine, according to service type information of currently-used service and the mapping relationship, the DRX configuration information corresponding to the currently-used service.
